(19) United States
(12) Patent Application Publication
(10) Pub. No.: US 2026/0026524 A1
(43) Pub. Date: Jan. 29, 2026

(54) METHODS OF PRODUCTING HIGH PROTEIN LEVELS IN CONFECTIONS AND HIGH PROTEIN CONFECTIONS

(71) Applicant: Glanbia Nutritionals Limited, Kilkenney (IE)

(72) Inventors: Niels J. Palmer, Twin Falls, ID (US); Brent Petersen, Twin Falls, ID (US)

(21) Appl. No.: 19/283,370

(22) Filed: Jul. 29, 2025

Related U.S. Application Data
(60) Provisional application No. 63/676,571, filed on Jul. 29, 2024.

(51) Int. Cl. A23G 3/44; A23G 3/34; A23G 3/42; A23G 3/48; A23G 3/50

(52) U.S. Cl. CPC A23G 3/44; A23G 3/0014; A23G 3/42; A23G 3/48; A23G 3/50

(57) ABSTRACT

Certain aspects provide methods of producing a high protein confection, comprising the steps: (a) mixing wet ingredients, dry ingredients and a protein ingredient in a cooking chamber to form a raw confection, wherein the cooking chamber is at a temperature of about 35° C. to about 60° C., and (b) applying a vacuum to the cooking chamber to about −15 in. Hg to about −29 in. Hg while continuing to mix the raw confection to form a finished confection. Certain aspects provide a high protein confection made by these methods.

### CROSS-REFERENCE TO RELATED APPLICATION

This application claims priority to U.S. Provisional Application No. 63/676,571 that was filed on Jul. 29, 2024. The entire content of the applications referenced above is hereby incorporated by reference herein.

### BACKGROUND

Caramel has a long history of being consumed as an indulgent confectionery treat. It can be enjoyed by itself or as an inclusion to enhance the eating experience. With a consumer shift in health and well-being trends, confectionary treats high in carbohydrates have a narrowing place in the modern diet. The modern diet is built for a fast-paced world and prioritizes nutrition and taste that can be delivered with speed and efficiency. Protein bars have become popular options in this environment because of their convenience and nutritional density, but they often struggle to provide an enjoyable eating experience. In order to meet the customers' demand for sweetness, protein bar manufacturers have tried to add a layer of caramel. Unfortunately, caramel's high carbohydrate profile does not fit the macronutrient requirements of a protein bar. Although confectionery manufacturers have tried to decrease carbohydrate loads by replacing it with protein, this has only been achieved at a minimal level of 5-10% replacement. Higher protein replacement with protein in the 10%-20% range, negatively impacts the caramel quality. Caramels with protein concentration greater than 20% turns the caramel into a large unmalleable mass.

Accordingly, improved processes are needed to make a confectionary high protein caramel that meets both the demands of the modern high protein diet, with the indulgent feel of confectionary caramel.

### SUMMARY

In one aspect, provided herein is a method of producing a high protein confection, comprising (or consisting of, or consisting essentially of) the steps:
(a) mixing wet ingredients, dry ingredients and a protein ingredient in a cooking chamber to form a raw confection,
   wherein the wet ingredients comprise 0-15% liquid, 5-35% fiber syrup, and 0-10% sugar alcohol;
   wherein the dry ingredients comprise 8-20% sugar, 8-15% fruit flakes or dry fruit powder and 0-3% flavor enhancer compound;
   wherein the protein ingredient comprises 20-60% protein powder;
   wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In one aspect, provided herein is a method of producing a high protein confection, comprising (or consisting of, or consisting essentially of) the steps:
(a) mixing wet ingredients, dry ingredients and a protein ingredient in a cooking chamber to form a raw confection,
   wherein the wet ingredients comprise 0-15% water, 5-35% fiber syrup, and 0-10% sugar alcohol;
   wherein the dry ingredients comprise 5-45% sugar, 2-15% lipid, and 0-3% flavor enhancer compound;
   wherein the protein ingredient comprises 20-60% protein powder;
   wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In one aspect, provided herein is a method of producing a high protein confection, comprising (or consisting of, or consisting essentially of) the steps:
(a) mixing wet ingredients, dry ingredients and a protein ingredient in a cooking chamber to form a raw confection,
   wherein the wet ingredients comprise 0-15% water, 5-80% non-nutritive carbohydrate, and 0-11% sugar alcohol;
   wherein the dry ingredients comprise 2-15% lipid, 5-45% non-nutritive carbohydrate, and 0-3% flavor enhancer compound;
   wherein the protein ingredient comprises 20-60% protein powder;
   wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In one aspect, provided herein is a high protein confection made by the methods described herein.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1. High protein caramel made with traditional stovetop method, and temperature that product reached.

FIG. 2. The sample bar on the left was made with traditional protein bar method in mixer. The sample on the right is the same formula but made with the new caramel process described herein.

FIG. 3. Six months aged samples. The left sample was made traditional mixing process. The sample on the right is the same formula but made with the new caramel process described herein.

FIG. 4. Six months aged samples. The left sample was made traditional mixing process, with short texture. The sample on the right is the caramel made in new caramel process, and the caramel was stretchy and chewy.

FIG. 5. Process flow chart.

### DETAILED DESCRIPTION

There have been many attempts to bridge the gap between caramel and high protein bars. Defining the standard process for caramel and protein bar manufacturing, will help understand this gap and the beauty of this invention in bringing them together. In making standard caramel, the sugar system is heated to high temperatures of 118° C. to 121° C., so the sugars undergo a molecular change of caramelization. These high temperatures allow the water to evaporate and the sugars in the system to form a supersaturated system. The fats and other additives in the system interfere with the crystalline structure of the sugar to keep the sugar in an amorphous state instead of forming a rigid crystal. In order to have it remain in the stretchy caramel state, water must be boiled off at these high temperatures. Water removal is important because water that remains in the system is bound loosely to the sugars. It can be measured by a process known as water activity. Water activity verifies that the caramel is shelf-stable from microbes' growth. In order for a neutral pH system like a caramel to be shelf-stable it has to have water activity (a_{w}) below 0.68 a_{w}. A standard caramel has water activity around 0.3 a_{w}. In commercial caramel manufacturing, a vacuum is often pulled on the system to lower the boiling point and to remove the water at an accelerated rate to reach the end point sooner.

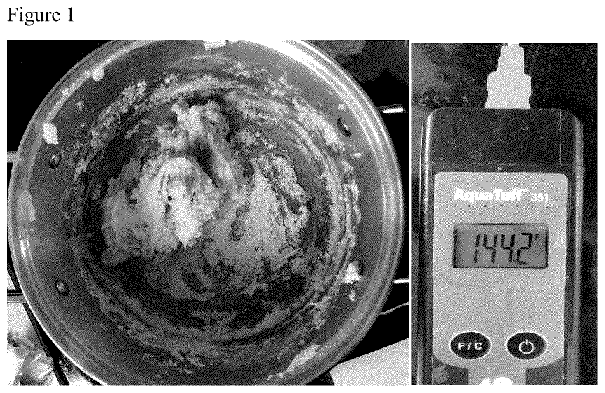

When proteins are added to the caramel system, they often interfere with sugars to keep them in an amorphous structure. Proteins bind water closely and this requires longer heat exposure to reach the temperature needed in a standard caramel make. Proteins begin to denature and unravel when exposed to this extreme heat for an extended time. This causes nucleation sites for the supersaturated sugar solution to crystallize, and the caramel loses its stretchy texture and becomes gritty and hard. Whey protein in particular is unsuitable for caramel, because of its heat sensitivity, and denatures around 150° F. to form bonds that are rigid in structure (see FIG. 1). In low levels about 5% protein, the caramel can include stabilizers and other components like fats and sugars, to prevent the denatured protein from forming a rigid network and structure in the caramel. Proteins at an inclusion greater than 10% protein, burn and foul the caramel process. Attempts have been made to bypass the heat exposure to the protein, by adding the protein after the heat step is completed. Protein cannot be added at the end of the caramel making process, however, because there is no longer enough moisture to hydrate the protein and it loses its characteristic properties.

Standard high protein bars generally consist of a nugget protein center, with inclusions such as nuts, chunks, or crisps. There is sometimes a thin caramel or fudge layer, and then everything is coated in a thin chocolate layer. Protein content of these bars is targeted around 16 g-20 g protein per serving with the serving size ranging from 45 g-90 g. The macro breakdown for high protein bars generally consists of 25-40% protein, 30-45% carbohydrate, 10-20% fat, with the remaining 5-15% being made up of minerals and water. Thus, there is no room in a protein bar for more than a thin layer of a standard caramel.

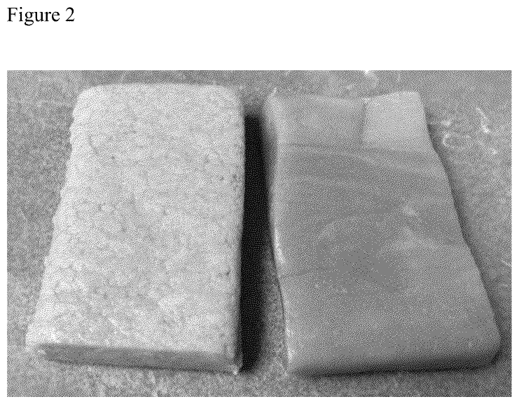

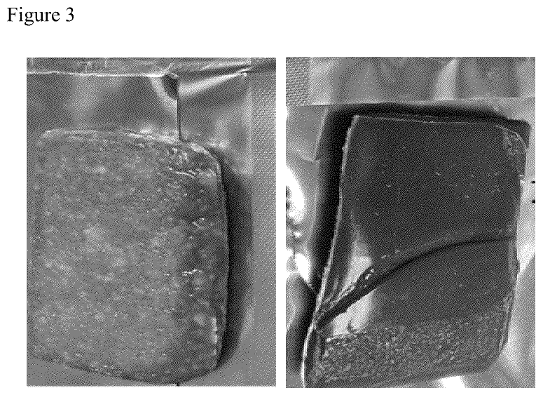

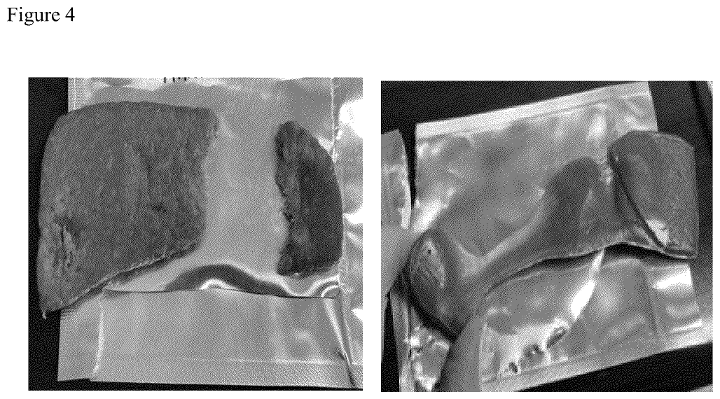

The standard process for manufacturing protein bars involves mixing the dry powder ingredients and wet ingredients (fiber syrups, sugar syrups, and water) separately. Then, the wet and the dry ingredients are mixed until uniformly combined into a nugget mass. In certain embodiments, the protein ingredient is added after the wet and dry ingredients have been combined. The nugget mass is then extruded through a low-pressure extruding head and rolled and pressed into the desired shape before being cut to appropriate size. The wet ingredients can be heated to hydrate the protein powders more efficiently during the mixing process. It is not common to apply any heat to the nugget material, because when it is formed and cut, it needs to hold its shape for packing. When these protein bars are first made the nugget is soft without any stretch (see FIGS. 2 and 3). As the bars age over the next 6-12 months the texture stiffens and becomes hard (see FIG. 4). Taffy-like or stretchy centers of protein bars are not possible while still keeping the bar shelf-stable with the water activity below 0.68 a_{w}.

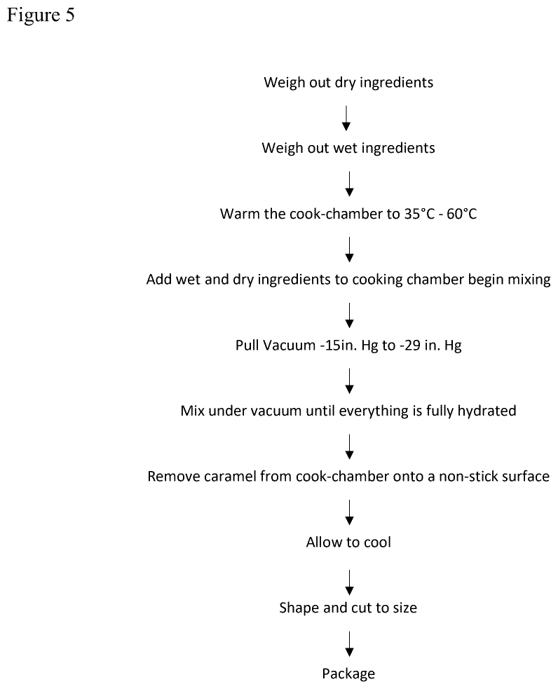

In order to develop a high protein caramel, a novel manufacturing process was needed (see FIG. 5). The process developed used heat and vacuum as well as formulation and macros of a high protein bar. First, the dry ingredients were blended uniformly, and then the liquids were mixed in. Heat was applied while the wet and dry ingredients were blended together, which improved hydration and allowed the ingredients to mix more evenly. A vacuum was then pulled on the system while heating and mixing. Once mixing and heating was completed, the vacuum was released, and the caramel was removed and allowed to cool. It was then formed and packaged.

Heat alone will not result in a caramel structure. Pulling a vacuum in a high protein caramel system changes the functionality of the protein and the system. A vacuum is not required in a standard caramel making process because the carbohydrates in the caramel are hydrophilic and can completely hydrate. Carbohydrates are also heat stable and can withstand high heat without denaturing, so any excess water added to the system can be boiled off at normal atmosphere. Pulling a vacuum on a high protein mixing system transformed the protein mass from a short nugget to a stretchy caramel. The vacuum allowed the proteins to relax and allowed for more interaction. Without being bound by theory, another possible reason for this change in texture and function was the change in boiling point. When the vacuum was pulled on the system, the atmospheric pressure on the system was reduced, thus decreasing the temperature required to bring the system to a boil. When a sufficient vacuum was pulled, the boiling point is below denaturation temperatures, which allowed the protein and sugar syrup to move and interact in a more fluid environment.

Water is not a common addition to protein bars as it makes the water activity (a_{w}) too high. The benefit of softness that comes from adding water to hydrate the protein is outweighed by the protein bar not being shelf-stable due to high water activity. Water is needed in the present caramel process in order to fully hydrate the proteins. This hydration of the protein changes the functionality of the bar from short and stiff to a longer, taffy-like stretchy characteristic. Water activity, however, needs to be monitored for this process because water is added to the present system. In side-by-side experiments, one that used a vacuum and one that did not, the product produced under vacuum showed significantly lower water activity, 0.66 a_{w}, than the one without the vacuum, 0.71 a_{w}. Without being bound by theory, there are two possible explanations for this difference. First, the vacuum may have pulled off minimal amounts of moisture vapors from the system's air during processing. Second, the vacuum may have pulled micro air pockets trapped in the product, which allowed the water in the system to interact with the hydrophobic portions of the protein and bind more water. It would decrease the free water available in the system, which correlates to a_{w}.

Proteins in general have hydrophobic properties. When mixing whey protein in water it is generally sprayed with lecithin, in a process called agglomeration or instantization. Lecithin, an emulsifier, is designed to break surface tension and allow water to interact with and fully hydrate the protein. These lecithinated protein powders need large amounts of water to hydrate the protein under normal atmospheric pressure. In protein bars a minimal amount of free water is available. Water activity needs to be kept at a minimum so that it meets the requirements remaining below 0.68 a_{w} in order to be shelf stable. Without being bound by theory, it is thought that the hydrophobic portions of the protein trap micro pockets of air around the product to provide a type of insulation, thus preventing the water from fully interacting with the protein. Any free water in the system only interacts with the hydrophilic portion of the protein. There is not enough energy to overcome the micro air pockets around the hydrophobic protein and hydrate the complete protein. When a vacuum is pulled, it pulls air out of the system. The micro air pockets expand due to pressure differences, which allows the air pockets to coalesce. The hydrophobic portions of the protein do not have the energy to hold large air pockets and the water is able to penetrate these hydrophobic sections and completely hydrate the protein. With the protein fully soluble, it is more malleable and stretchy, like a caramel (see FIG. 4).

Nugget portions of protein bars are not all the same. The protein composition of the nugget affects the mouthfeel and texture characteristics of the bar. Caramel made with high levels of hydrolyzed proteins is soft and sticky. Nugget made with whey protein concentrate inside the caramel coating decreases the tackiness of the caramel in the mouth. In contrast, milk protein isolate in the nugget provides a firmer caramel with better standup and less cold flow. Variation in blends of the whey protein concentrate and milk protein isolate can be used to produce functional characteristics of the caramel.

Just as different proteins can be used in a formula to target specific functional characteristics, the same principle can be applied to the other components of a caramel. There has been extensive protein bar research to show that fat and oil with different melting points affect mouthfeel. Sugar syrups and fiber syrups have varying degrees of solidity and viscosity which affect tackiness or stretch. Allulose can be used in place of the sugar in the caramel to provide the necessary structure for the caramel, without it being declared as an added sugar. This is significant because added sugars are now required to be declared on ingredient labels. The present invention provides a novel high-protein, keto-friendly, zero net-carbs caramel.

Fruit and chocolate flavors are added to confectionery caramel to provide diversity of experience beyond the standard, brown sweet notes of a caramel. The caramel process is used as the base for an array of treats. The process of the present invention is very versatile in that, just as caramel is a base for many products, this process is sufficiently robust as a base to develop a wide variety of applications and products. As a proof of concept for one application with this caramel process, a fruit taffy was developed (see Example 3 below). This caramel contained real fruit particles and was able to maintain protein levels of around 40%. Just as with the protein caramel process, changing the type of protein, carbohydrate/fiber syrup, or fat in the formula can target specific functionality of the final product no matter the flavor.

This process produces a confectionary high protein caramel containing 20-60% protein that maintains the indulgent feel of a confectionary caramel.

### Method of Producing a High Protein Confection

Methods of making a confection are provided.

In one aspect, provided herein is a method of producing a high protein confection, comprising (or consisting of, or consisting essentially of) the steps:
(a) mixing wet ingredients, dry ingredients and a protein ingredient in a cooking chamber to form a raw confection,
   wherein the wet ingredients comprise 0-15% liquid, 5-35% fiber syrup, and 0-10% sugar alcohol;
   wherein the dry ingredients comprise 8-20% sugar, 8-15% fruit flakes or dry fruit powder and 0-3% flavor enhancer compound;
   wherein the protein ingredient comprises 20-60% protein powder;
   wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In one aspect, provided herein is a method of producing a high protein confection, comprising (or consisting of, or consisting essentially of) the steps:
(a) mixing wet ingredients, dry ingredients and a protein ingredient in a cooking chamber to form a raw confection,
   wherein the wet ingredients comprise 0-15% water, 5-35% fiber syrup, and 0-10% sugar alcohol;
   wherein the dry ingredients comprise 5-45% sugar, 2-15% lipid, and 0-3% flavor enhancer compound;
   wherein the protein ingredient comprises 20-60% protein powder;
   wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In one aspect, provided herein is a method of producing a high protein confection, comprising the steps:
(a) mixing wet ingredients, and dry ingredients and a protein ingredient in a cooking chamber to form a raw confection,
wherein the wet ingredients comprise 0-15% water, 5-80% non-nutritive carbohydrate, and 0-11% sugar alcohol;
wherein the dry ingredients comprise 20-60% protein powder, 2-15% lipid, 5-45% non-nutritive carbohydrate, and 0-3% flavor enhancer compound;
wherein the protein ingredient comprises 20-60% protein powder;
wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

In certain aspects, the cooking chamber is warmed to about 35° C. to about 60° C. prior to the introduction of the wet and/or dry ingredients into the cooking chamber.

In certain aspects, the mixing in part (b) continues until the ingredients are fully hydrated. This will be apparent to some skilled in the art when the confection (e.g., a caramel) begins to boil and turn from off-white to an opaque.

In certain aspects, the liquid is water, fruit juice and/or a fruit concentrate.

The high protein confection is removed from the cook chamber when the cook process is complete, as determined by someone skilled in art of confectionary. It is then formed, cut and shaped.

In certain aspects, the wet ingredients comprise a protein slurry, bloomed gelatin and/or hydrated dairy protein.

In certain aspects, the wet ingredients further comprise a non-nutritive carbohydrate.

In certain aspects, the non-nutritive carbohydrate is a polyol.

In certain aspects, the non-nutritive carbohydrate is allulose.

In certain aspects, the finished confection is devoid of glycerol.

In certain aspects, the wet ingredients comprise a carbohydrate syrup, in place of water and dry sugars or sugar substitutes.

In certain aspects, the dry ingredients comprise dairy protein powder.

In certain embodiments the dairy powder protein comprises whey protein isolate, hydrolyzed whey protein, sweet whey, acid whey, whey protein concentrate, milk protein, caseinate, nonfat dry milk, etc.

In certain aspects, the dairy protein powder comprises whey protein powder, and the whey protein powder comprises partially hydrolyzed whey protein isolate with a protein level of 70-98% dry matter basis.

In certain aspects, the dry ingredients comprise a blend of dairy protein and plant and/or non-dairy animal protein.

In certain aspects, the dry ingredients comprise non-dairy protein.

In certain aspects, the non-dairy protein comprises egg protein, gelatin, collogen, hydrolyzed collogen, and/or plant protein.

In certain aspects, the non-dairy animal protein is egg protein, gelatin, collogen, and/or hydrolyzed collogen.

In certain aspects, the protein powder comprises plant protein.

In certain aspects, the plant protein is pea, rice, sunflower, canola, potato and/or soy.

In certain aspects, the amount of protein in the finished product is 18-50%.

In certain aspects, the wet ingredients are mixed with the dry ingredients prior to the addition of the protein ingredients.

In certain aspects, the confection has a pH of less than 4.5.

In certain aspects, the dry ingredient comprises 20-60% protein powder, 5-45% sugar, 2-8% lipid and 0-3% flavoring compound.

In certain aspects, the cooking chamber is warmed to about 35° C. to about 60° C. prior to the introduction of the wet and/or dry ingredients into the cooking chamber. In certain aspects, the cooking chamber is warmed to 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., or 65° C.

As used herein, in certain aspects, the term “comprising” can be substituted with the term “consisting of,” or “consisting essentially of” with respect to the method.

### High Protein Confection

In one aspect wherein the wet ingredients comprise water, carbohydrates including fiber syrups, polyols, sugar syrups. Fruit juice or fruit concentrates, oil, liquid flavors, hydrated protein solution.

In certain aspects, the dry ingredients comprise dairy powder protein (examples: whey protein isolate, hydrolyzed whey protein, sweet whey, acid whey, whey protein concentrate, milk protein, caseinate, nonfat dry milk, etc.).

In certain aspects, the dry ingredients comprise non-dairy protein, such as egg protein, gelatin, collogen, hydrolyzed collogen, etc.

In certain aspects, the non-dairy protein comprises plant proteins, such as pea, rice, sunflower, canola, potato, soy, etc.

In certain aspects, the dry ingredients comprise sugar or sugar substitute, fruit powders or dried fruit particle, lipids isolated from plants or animals, flavor compounds including salts, high intensity sweeteners, and acidulants.

In certain aspects, the amount of protein in the finished product is 18-50%.

In certain aspects, the dry ingredient comprises 20-60% protein powder, 5-45% sugar, 2-8% lipid and 0-3% flavoring compound.

In one aspect, provided herein is a high protein confection, comprising 0-15% water, such as 8-15% water, or 11-14% water, i.e., comprising 0%, 1%, 2%, 3%, 4%, 5%, 6%, 7%, 8%, 9%, 10%, 11%, 12%, 13%, 14%, or 15%.

In certain aspects, the high protein confection comprises fiber syrup with a dextrose equivalent of 2-10 de (e.g., 2 de, 3 de, 4 de, 5 de, 6 de, 7 de, 8 de, 9 de, or 10 de). In certain aspects, the fiber syrup is present at a concentration of about 5-35%, such as at a concentration of 10-14%, i.e., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35%.

In certain aspects, polyol is present at a concentration of 0-15%, such as at a concentration of 7-11%, i.e., comprising 0%, 1%, 2%, 3%, 4%, 5%, 6%, 7%, 8%, 9%, 10%, 11%, 12%, 13%, 14%, or 15%.

In certain aspects, the dry powder comprises 20-60% protein powder, such as 20-60% whey protein, i.e., 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60%. In certain aspects the whey protein is partially hydrolyzed whey protein isolate with a protein of 70-98% dry matter basis; i.e., 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, or 98%.

In certain aspects, the dry powder comprises 5-45% sugar, such as 8-20% sugar, or 10-15% sugar; i.e., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, or 45% sugar.

In certain aspects, the dry powder comprises 2-8% lipid; i.e., 2%, 3%, 4%, 5%, 6%, 7%, or 8%.

In certain aspects, the dry powder comprises 0-3% flavoring compounds; i.e., 0%, 1%, 2%, or 3% flavoring compounds.

In certain aspects, provided herein is a high protein confection made by a method described herein, wherein the carbohydrates used in the confection results in a low glycemic response.

In certain aspects, provided herein is a high protein confection made by a method described herein, wherein the carbohydrates used in the confection results near net zero calories form carbohydrates, resulting in a Keto friendly type confection.

In certain aspects, provided herein is a high protein confection, wherein the water activity of the confection is 0.7 a_{w} or below.

In certain aspects, provided herein is a high protein confection, wherein in the high protein confection maintains its malleable, stretch or flexible characteristics over the self-life of the confection.

In certain aspects, provided herein is a high protein confection, wherein the high protein confection comprises 0-15% water, 5-35% fiber syrup, and 0-15% polyol.

In certain aspects, provided herein is a high protein fruit leather confection comprising:
(a) 20-60% protein powder,
(b) 0-15% water,
(c) 5-35% fiber syrup
(d) 0-10% sugar alcohol,
(e) 8-20% sugar,
(f) 8-15% fruit flakes or dry fruit powder, and
(g) 0-3% flavor enhancer compound,
wherein the confection is 18-50% protein.

In certain aspects, provided herein is a high protein fruit leather confection comprising:
(a) 40-50% protein powder,
(b) 11-14% water,
(c) 10-14% fiber syrup
(d) 0-10% sugar alcohol,
(e) 8-10% sugar,
(f) 8-12% fruit flakes, and
(g) 1-2% flavor enhancer compound,
wherein the confection is 18-50% protein.

In certain aspects, the high protein fruit leather confection has a pH of less than 4.5.

In certain aspects, the confection comprises 1-5% sugar alcohol.

In certain aspects, a method of producing a high protein confection with 0 calories coming from carbohydrates or keto-type, high protein confection, the wet ingredients comprise water from 0-15%, or 8-15% water; fiber syrup with a dextrose equivalent of 2-10 de from 5-35% (would provide no calories when digested), and 7-11% polyol, which is non-caloric when digested. In certain aspects, the dry powder is comprised of 20-60% protein powder. In certain aspects, the dry powder is 20-60% Whey protein. In certain aspects, the dry powder is partially hydrolyzed whey protein isolate with a protein of 70-98% dry matter basis. An insolate with greater than 90% protein provides a negligible amount of calories coming from carbohydrates such as lactose or other natural sugars. In certain aspects, a sugar substitute such as 5-45% allulose is provided. In certain aspects, a sugar substitute such as 10-15% allulose is provided. In certain aspects, 2-15% Lipid is provided. In certain aspects, 0-3% flavoring compounds are provided. In certain aspects, for the composition to be a keto-type of high protein confection, the flavor compounds does not contain carbohydrates, such as maltodextrins or polydextrose as carriers.

In certain aspects, a high acid (e.g., pH 2.5 to pH 5.5), confection is processed and combined with fruit particulates or fruit flavors to make a high protein fruit leather or fruity confection. In certain aspects, the confection contains water from 0-15%. In certain aspects, the confection contains water from 11-14%. In certain aspects, the confection contains fiber syrup from 5-35%. In certain aspects, the confection contains 10-14% fiber syrup. In certain aspects, the confection contains 0-15% polyol. In certain aspects, the confection contains 7-11% polyol. In certain aspects, the dry powder is comprised of 20-60% protein powder. In certain aspects, the dry powder is comprised of 20-60% Whey protein. In certain aspects, the dry powder is comprised of partially hydrolyzed pre-acidified whey protein isolate with a protein of 70-98% dry matter basis. In certain aspects, the confection comprises 8-20% sugar. In certain aspects, the confection is comprised of 8-10% sugar. In certain aspects, the confection is comprised of 0-15% dried fruit powder or dried fruit flakes. In certain aspects, the confection is comprised of 8-12% dried fruit powder or dried fruit flakes. In certain aspects, the confection comprises 0-3% flavoring compounds.

In some embodiments, the soluble fiber can be included in an amount of about 5% to about 35% by dry weight of the confection. As used here, a soluble fiber included in a confection provided herein has a degree of polymerization (DP) of less than 10 (e.g., from 2 to 10). Suitable fiber includes, for example, inulin, polydextrose, soluble corn fiber, sugarcane fiber (cellulose), or any combination thereof. In some embodiments, a fiber syrup, such as liquid inulin, liquid soluble corn fiber, and liquid polydextrose can be used. In some embodiments, a combination of a fiber syrup and a powdered fiber can be used. In some embodiments, powder and liquid sources can be used.

In some embodiments, the confection comprises Dairy Powder protein (examples: Whey protein isolate, hydrolyzed whey protein, sweet whey, acid whey, Whey protein concentrate, Milk protein, caseinate, nonfat dry milk, etc.), other non-dairy animal protein (egg protein, gelatin, collogen, hydrolyzed collogen, etc.), and/or Plant proteins (such as pea, rice, sunflower, canola, potato, soy, etc.). In certain aspects, the Whey protein is included in an amount of about 20% to about 60% by dry weight of the confection. In certain aspects, partially hydrolyzed whey protein isolates are at least 70% of the protein on a dry matter basis. In certain aspects, partially hydrolyzed whey protein isolates are 70 to 98% protein on dry matter basis.

In some embodiments, the confection comprises Polyols such as glycerin, maltitol, or other sugar alcohols in an amount of about 7% to about 11% by dry weight of the confection.

In some embodiments, the confection comprises animal fat such as cream or butter in an amount of about 0% to about 15% by dry weight of the confection. The fat or lipids can be isolated from plant or animal sources. Any edible fat can be used in a confection provided herein. Suitable fats for providing a creamy mouthfeel include liquid oils (e.g., sunflower oil, canola oil, and the like), shortenings (e.g., palm-based shortenings, coconut oil-based shortenings, and the like), and low to moderate melting point solid fats (e.g., whole palm oil, palm kernel oil, coconut oil, and the like). Although in certain aspects, confections can comprise higher melt-point fats (e.g., stearines and stearine blends), they are more likely to create a waxy mouthfeel when included at amounts at the higher end of the range. In certain aspects, a fat type and an amount of fat is adjusted based on the desired nutritional profile of a confection provided herein.

In some embodiments, confections comprise an emulsifier in an amount of up to 4% (e.g., up to 3%, up to 2%, or up to 1.5%) by dry weight of the confection. In certain aspects, the emulsifier is applied on the protein or other dried powder as an instantizer to improve hydration of powder. In certain aspects, the method comprises adding the emulsifier separately to the confection. Any appropriate emulsifier can be used. In some embodiments, some or all of the emulsifier content in the confection comprises a fat ingredient.

In some embodiments, the pH is from about 3 to about 7 (e.g., pH of 3, 4, 5, 6, or 7). The pH of the finished confection is a food safe acid, such as phosphoric, citric, malic, or acetic acid. pH can aid in the self-stability of the product as well as the aging process. For example, confections with a pH lower than 4.6 are considered a high acid product and do not rely on the water activity as heavily to control microorganisms in a finished product. pH can also affect chemical reactions such as Maillard browning a protein and reducing sugar interaction.

In some embodiments, the confection contains additional ingredients in an amount up to about 5% by dry weight of the confection. In some embodiments, the additional ingredients include flavors, flavor enhancers, extracts, artificial sweeteners, salts, or vitamin and mineral premix.

In certain aspects, provided herein is a high protein confection comprising:
(a) 20-60% protein powder,
(b) 0-15% water,
(c) 5-35% fiber syrup
(d) 0-10% sugar alcohol,
(e) 5-45% sugar,
(f) 2-15% lipid, and
(g) 0-3% flavor enhancer compound,
wherein the confection is 18-50% protein.

In certain aspects, provided herein is a high protein confection comprising:
(a) 40-50% protein powder,
(b) 11-14% water,
(c) 10-14% fiber syrup
(d) 0-10% sugar alcohol,
(e) 8-20% sugar,
(f) 2-8% lipid, and
(g) 1-2% flavor enhancer compound,
wherein the confection is 18-50% protein.

In certain aspects, provided herein is a high protein confection consisting of:
(a) 47% whey protein isolate,
(b) 11% water,
(c) 13% fiber syrup,
(d) 0-10% sugar alcohol,
(e) 11% sugar,
(f) 5% lipid, and
(g) 2% flavor enhancer compound,
wherein the confection is 39% protein.

In certain aspects, provided herein is a high protein confection consisting of:
(a) 46.66% partially hydrolyzed protein,
(b) 6.36% water,
(c) 10.60% soluble fiber syrup,
(d) 10.60% carbohydrate syrup,
(e) 12.73% sugar,
(f) 10.60% lipid, and
(g) 2.44% flavor enhancer compound.

In certain aspects, provided herein is a high protein confection with net zero calories from carbohydrates consisting of:
(a) 45.69% partially hydrolyzed protein,
(b) 14.54% soluble fiber syrup,
(c) 27% allulose,
(d) 10.38% fat, and
(e) 2.39% flavor enhancer compound.

In certain aspects, provided herein is amid-level protein confection with net zero calories from carbohydrates consisting of:
(a) 25.12% partially hydrolyzed protein,
(b) 14.54% soluble fiber syrup,
(c) 47.75% allulose,
(d) 10.38% fat, and
(e) 2.22% flavor enhancer compo

In certain aspects, provided herein is a protein confection with net zero calories from carbohydrates consisting of:
(a) 36.92% partially hydrolyzed protein,
(b) 14.68% soluble fiber syrup,
(c) 35.66% allulose,
(d) 10.38% fat, and
(e) 2.24% flavor enhancer compound.

As used herein, in certain aspects, the term “comprising” can be substituted with the term “consisting of,” or “consisting essentially of” with respect to the confection.

The invention will now be illustrated by the following non-limiting Examples.

### Example 1

The equipment used in the process was a Stephon lab mixer. The bowl is jacketed for heated water while mixing. A lid is secured to the top on the Stephon mixing bowl so that vacuum can be pulled on the system. The vacuum pump used is a fisher scientific Maxima C plus Model M2C. A flow chart is provided in FIG. 5.

Base Caramel Formula

| | Weight |
|---|---|
| Ingredients | Percent |
| Partially hydrolyzed Whey protein isolate | 47% |
| water | 11% |
| Fiber syrup | 13% |
| Sugar alcohol | 11% |
| Sugar | 11% |
| Lipid | 5% |
| Flavor enhancer and compounds | 2% |
| Total | 100% |
| Percent protein in finished confection | 41% |
| Calculated Calories from carbohydrates in 100 g | 44 |

### Example 2

Keto or net zero calories from carbohydrates

| | WEIGHT |
|---|---|
| INGREDIENTS | PERCENT |
| Partially hydrolyzed Whey protein isolate | 47% |
| Water | 11% |
| Fiber syrup | 13% |
| Sugar alcohol | 11% |
| Sugar substitute such as allulose | 11% |
| Lipid | 5% |
| Flavor enhancer and compounds | 2% |
| Total | 100% |
| Percent protein in finished confection | 41% |
| Calculated Calories from carbohydrate | 0 |

### Example 3

Base Fruit Leather Formula

| | Weight |
|---|---|
| Ingredients | Percent |
| Partially hydrolyzed pre acidified whey protein | 47% |
| isolate | |
| Water | 12% |
| Fiber syrup | 12% |
| Sugar alcohol | 10% |
| Sugar | 8% |
| Fruit flakes | 10% |
| Flavor enhancer compounds | 2% |
| Total | 100% |
| Percent protein in finished confection | 39% |

### Example 4

High Protein Caramel Net Zero Calories
From Carbohydrate Formula

| | Weight |
|---|---|
| Ingredients | Percent |
| Partial hydrolyzed Protein | 45.69% |
| soluble fiber syrup | 14.54% |
| allulose syrup | 27.00% |
| fat | 10.38% |
| flavor | 2.39% |
| | 100.00% |

### Example 5

Mid-level protein caramel net zero
calories from carbohydrate formula

| | Weight |
|---|---|
| Ingredients | Percentage |
| Partial hydrolyzed Protein | 25.12% |
| soluble fiber syrup | 14.53% |
| allulose syrup | 47.75% |
| fat | 10.38% |
| Flavor | 2.22% |
| | 100.00% |

### Example 6

Protein first on the label net zero
calories from carbohydrates formula

| | Weight |
|---|---|
| Ingredients | Percentage |
| Partial hydrolyzed Protein | 36.92% |
| soluble fiber syrup | 14.68% |
| allulose syrup | 35.66% |
| fat | 10.49% |
| flavor | 2.24% |
| | 100.00% |

### Example 7

High protein caramel formula

| | Weight |
|---|---|
| Ingredients | Percentage |
| Partial hydrolyzed Protein | 46.66% |
| water | 6.36% |
| soluble fiber syrup | 10.60% |
| carbohydrate syrup | 10.60% |
| sugar | 12.73% |
| fat | 10.60% |
| flavor | 2.44% |

Although the foregoing specification and examples fully disclose and enable the present invention, they are not intended to limit the scope of the invention, which is defined by the claims appended hereto.

All publications, patents and patent applications are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context.

As used herein, the term “about,” when referring to a value is meant to encompass variations of, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. It is understood that embodiments described herein include “consisting of” and/or “consisting essentially of” embodiments.

The transitional phrase “consisting of” excludes any element, step, or ingredient not specified in the claim.

“Consisting essentially of” generally limits a feature, compound, composition or method to the recited elements and/or steps but does not exclude the possibility of additional elements and/or steps that do not materially affect the function, compound, composition and/or characteristics of the recited feature, compound, composition or method. The transitional phrase “consisting essentially of” limits the scope of a claim to the specified materials or steps and those that do not materially affect the basic and novel characteristic(s) of the claimed invention.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of producing a high protein fruit leather confection, comprising the steps:
(a) mixing wet ingredients, dry ingredients and a protein ingredient in a cooking chamber to form a raw confection,
wherein the wet ingredients comprise 0-15% liquid, 5-35% fiber syrup, and 0-10% sugar alcohol;
wherein the dry ingredients comprise 8-20% sugar, 8-15% fruit flakes or dry fruit powder and 0-3% flavor enhancer compound;
wherein the protein ingredient comprises 20-60% protein powder;
wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

2. The method of claim 1, wherein the cooking chamber is warmed to about 35° C. to about 60° C. prior to the introduction of the wet and/or dry ingredients into the cooking chamber.

3. The method of claim 1, wherein the liquid is water, fruit juice and/or a fruit concentrate.

4. The method of claim 1, wherein the wet ingredients comprise a protein slurry, bloomed gelatin and/or hydrated dairy protein.

5. The method of claim 1, wherein the wet ingredients further comprise a non-nutritive carbohydrate.

6. The method of claim 5, wherein the non-nutritive carbohydrate is a polyol.

7. The method of claim 5, wherein the non-nutritive carbohydrate is allulose.

8. The method of claim 1, wherein the finished confection is devoid of glycerol.

9. The method of claim 1, wherein the protein powder comprises dairy protein powder.

10. The method of claim 9, wherein the dairy protein powder comprises whey protein powder, and the whey protein powder comprises partially hydrolyzed whey protein isolate with a protein level of 70-98% dry matter basis.

11. The method of claim 1, wherein the protein powder comprises a blend of dairy protein and plant and/or non-dairy animal protein.

12. The method of claim 1, wherein the protein powder comprises non-dairy protein.

13. The method of claim 1, wherein the amount of protein in the finished confection is 18-50%.

14. The method of claim 1, wherein the confection has a pH of less than 4.5.

15. A high protein fruit leather confection made by the method of claim 1, wherein the carbohydrates used in the confection result in at least one of a low glycemic response or net zero calories form carbohydrates, resulting in a Keto friendly type confection.

16. The high protein fruit leather confection of claim 15, wherein the water activity of the confection is 0.7 a_{w} or below.

17. A high protein fruit leather confection made by the method of claim 1, comprising:
(a) 20-60% protein powder,
(b) 0-15% water,
(c) 5-35% fiber syrup
(d) 0-10% sugar alcohol,
(e) 8-20% sugar,
(f) 8-15% fruit flakes or dry fruit powder, and
(g) 0-3% flavor enhancer compound,
wherein the confection is 18-50% protein.

18. The high protein confection of claim 15, wherein the confection has a pH of less than 4.5.

19. The high protein confection of claim 15, wherein the confection comprises 1-5% sugar alcohol.

20. A method of producing a high protein confection, comprising the steps:
(a) mixing wet ingredients, dry ingredients and a protein ingredient in a cooking chamber to form a raw confection,
wherein the wet ingredients comprise 0-15% water, 5-35% fiber syrup, and 0-10% sugar alcohol;
wherein the dry ingredients comprise 5-45% sugar, 2-15% lipid, and 0-3% flavor enhancer compound;
wherein the protein ingredient comprises 20-60% protein powder;
wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

21. The method of claim 20, wherein the cooking chamber is warmed to about 35° C. to about 60° C. prior to the introduction of the wet and/or dry ingredients into the cooking chamber.

22. The method of claim 20, wherein the wet ingredients are mixed with the dry ingredients prior to the addition of the protein ingredients.

23. The method of claim 20, wherein the wet ingredients comprise a protein slurry, bloomed gelatin and/or hydrated dairy protein.

24. The method of claim 20, wherein the wet ingredients further comprise a non-nutritive carbohydrate.

25. The method of claim 20, wherein the finished confection is devoid of glycerol.

26. The method of claim 20, wherein the protein powder comprises dairy protein powder.

27. The method of claim 26, wherein the dairy protein powder comprises whey protein powder, and the whey protein powder comprises partially hydrolyzed whey protein isolate with a protein level of 70-98% dry matter basis.

28. The method of claim 20, wherein the protein powder comprises a blend of dairy protein and plant and/or non-dairy animal protein.

29. The method of claim 20, wherein the protein powder comprises non-dairy protein.

30. The method of claim 20, wherein the amount of protein in the finished confection is 18-50%.

31. A high protein confection made by the method of claim 20, wherein the water activity of the confection is 0.7 a_{w} or below.

32. The high protein confection of claim 31, wherein in the high protein confection maintains its malleable, stretch or flexible characteristics over the self-life of the confection.

33. A high protein confection made by the method of claim 20, comprising:
(a) 20-60% protein powder,
(b) 0-15% water,
(c) 5-35% fiber syrup
(d) 0-10% sugar alcohol,
(e) 5-45% sugar,
(f) 2-15% lipid, and
(g) 0-3% flavor enhancer compound,
wherein the confection is 18-50% protein.

34. A method of producing a high protein confection, comprising the steps:
(a) mixing wet ingredients, dry ingredients and a protein ingredient in a cooking chamber to form a raw confection,
wherein the wet ingredients comprise 0-15% water, 5-80% non-nutritive carbohydrate, and 0-11% sugar alcohol;
wherein the dry ingredients comprise 2-15% lipid, 5-45% non-nutritive carbohydrate, and 0-3% flavor enhancer compound;
wherein the protein ingredient comprises 20-60% protein powder;
wherein the cooking chamber is at a temperature of about 35° C. to about 60° C., and
(b) applying a vacuum to the cooking chamber to about −15 in. Hg to about −29 in. Hg while continuing to mix the raw confection to form a finished confection.

35. The method of claim 34, wherein the cooking chamber is warmed to about 35° C. to about 60° C. prior to the introduction of the wet and/or dry ingredients into the cooking chamber.

36. The method of claim 34, wherein the wet ingredients are mixed with the dry ingredients prior to the addition of the protein ingredients.

37. The method of claim 34, wherein the wet ingredients comprise a protein slurry, bloomed gelatin and/or hydrated dairy protein.

38. The method of claim 34, wherein the non-nutritive carbohydrate is a polyol or allulose, or wherein the finished confection is devoid of glycerol.

39. The method of claim 34, wherein the protein powder comprises dairy protein powder.

40. The method of claim 39, wherein the dairy protein powder comprises whey protein powder, and the whey protein powder comprises partially hydrolyzed whey protein isolate with a protein level of 70-98% dry matter basis.

41. The method of claim 34, wherein the protein powder comprises a blend of dairy protein and plant and/or non-dairy animal protein.

42. The method of claim 34, wherein the protein powder comprises non-dairy protein.

43. The method of claim 34, wherein the amount of protein in the finished confection is 18-50%.

44. A high protein confection made by the method of claim 34, wherein the water activity of the confection is 0.7 an or below.

45. The high protein confection of claim 44, wherein in the high protein confection maintains its malleable, stretch or flexible characteristics over the self-life of the confection.
